(19) United States
(12) Patent Application Publication
(10) Pub. No.: US 2014/0213082 A1
(43) Pub. Date: Jul. 31, 2014

(54) PROTECTIVE COVER FOR CONNECTOR

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: WU ZHOU, Shenzhen (CN); XIAO-GANG YIN, Shenzhen (CN); LI-REN FU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/854,146

(22) Filed: Apr. 1, 2013

(30) Foreign Application Priority Data
Jan. 31, 2013 (CN) 201310038056.1

(51) Int. Cl. H01R 13/443

(52) U.S. Cl. CPC H01R 13/443
USPC 439/149

(57) ABSTRACT

A protective cover for a connector includes a non-conductive positioning plate and two non-conductive clamping plates located at two opposite sides of the positioning plate. The positioning plate and the clamping plates bound two positioning slots for receiving pins of the connector.

### BACKGROUND

1. Technical Field

The present disclosure relates to protective covers, and particularly to a protective cover for a connector.

2. Description of Related Art

In electronic devices, such as computers or servers, a number of connectors are mounted on a motherboard of the electronic devices. A plurality of pins of each connector is exposed on the motherboard. The exposed pins may be damaged during assembly or disassembly of the motherboard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an exploded, isometric view of an embodiment of a protective cover, together with a connector and a motherboard.

FIG. 2 is an assembled, isometric view of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one.”

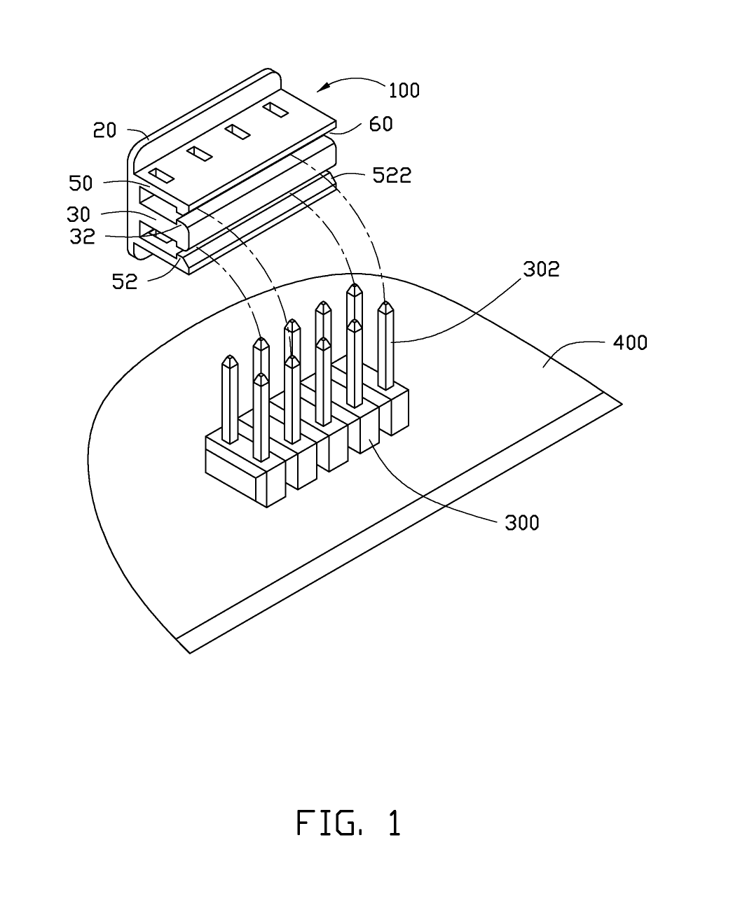

FIG. 1 shows an exemplary embodiment of a protective cover 100 for protecting a connector 300. The connector 300 is mounted on a motherboard 400. The connector 300 includes a plurality of pins 302 arrayed in two rows.

The protective cover 100 includes a rectangular top plate 20, a positioning plate 30 perpendicularly extending down from a middle of the top plate 20, and two resilient clamping plates 50 extending down from two sides of the top plate 20 and parallel to the positioning plate 30. Two positioning bars 32 protrude out from two sides of a bottom of the positioning plate 30. A distance between outer surfaces of the positioning bars 32 opposite to each other is equal to a distance between the two rows of the pins 302. A flange 52 protrudes from a bottom of each clamping plate 50 toward the positioning plate 30. Each clamping plate 50 and the positioning plate 30 bound a positioning slot 60. A side of each flange 52 away from the top plate 20 defines a slantwise guiding surface 522.

In the embodiment, the protective cover 100 is made of non-conductive material, such as pliable plastic or rubber, and is integrally formed.

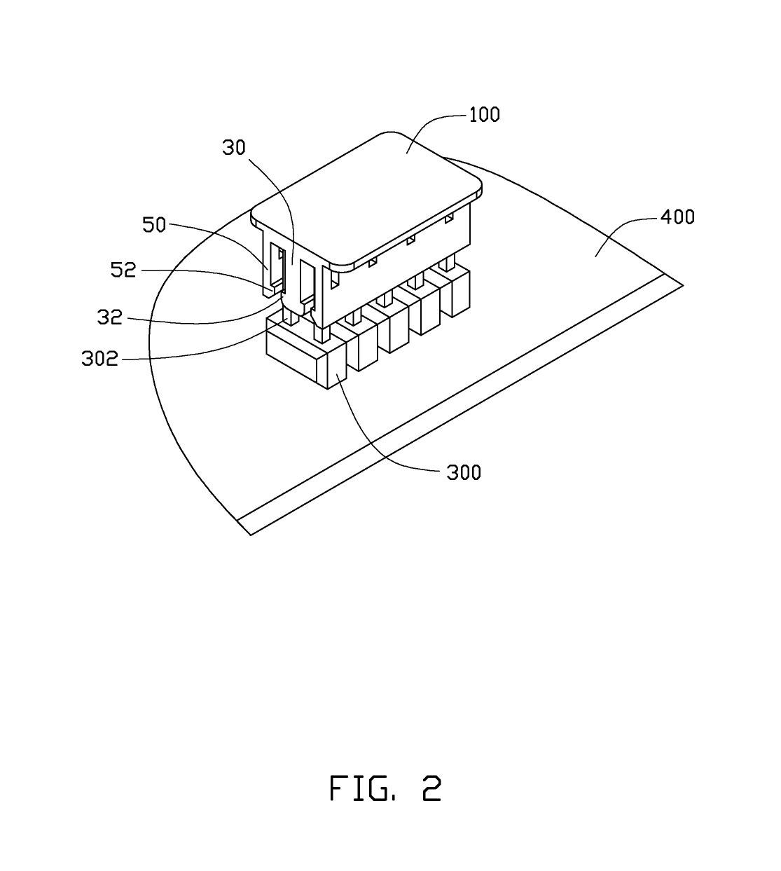

FIG. 2 shows that in use, the positioning slots 60 are respectively aligned with the two rows of pins 302. The top plate 20 is pressed toward the motherboard 400, the pins 302 of the connector 300 are inserted into the positioning slots 60, deforming the clamping plates 50. Therefore, bottom ends of the pins 302 of the connector 300 are abutted against and clamped by the corresponding positioning bars 32 and the corresponding flanges 52, to prevent the pins 302 from being deformed or damaged. The slantwise guiding surfaces 522 make the pins 302 easily enter the corresponding positioning slots 60.

While the disclosure describes examples and embodiments, it is to be understood that the disclosure is not limited thereto. To the contrary, the disclosure is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A protective cover for a connector with a plurality of pins, the protective cover comprising:
a non-conductive positioning plate; and
two non-conductive clamping plates parallel to the positioning plate, and located at two opposite sides of the positioning plate;
wherein the positioning plate and the clamping plates bound two positioning slots for receiving the plurality of pins.

2. The protective cover of claim 1, further comprising a top plate, wherein the positioning plate extends down from a middle of the top plate, and the clamping plates extend down from two sides of the top plate.

3. The protective cover of claim 2, wherein two positioning bars protrude out from two sides of a bottom of the positioning plate away from the top plate, for abutting against the plurality of pins.

4. The protective cover of claim 3, wherein a flange protrudes from a bottom of each clamping plate toward the positioning plate, the plurality of pins is clamped between the positioning bars and the corresponding flanges.

5. The protective cover of claim 4, wherein each flange defines a slantwise guiding surface opposite to the top plate.

6. The protective cover of claim 1, wherein the protective cover is made of plastic.

7. The protective cover of claim 1, wherein the protective cover is made of rubber.

8. An electronic device, comprising:
a motherboard;
a connector mounted on the motherboard, and comprising two rows of pins; and
a protective cover comprising a non-conductive positioning plate and two non-conductive clamping plates parallel to the positioning plate, and located at two opposite sides of the positioning plate;
wherein the positioning plate and the clamping plates bound two positioning slots, the two rows of pins of the connector are inserted into the positioning slots.

9. The electronic device of claim 8, wherein the protective cover further comprises a top plate, the positioning plates perpendicularly extends down from the top plate, the clamping plates extend down from two sides of the top plate.

10. The electronic device of claim 9, wherein two positioning bars protrude out from two sides of the positioning plate, for abutting against the two rows of pins.

11. The electronic device of claim 10, wherein a flange protrudes from each clamping plate toward the positioning plate, each row of pins is clamped between the corresponding positioning bar and the corresponding flange.

12. The electronic device of claim 8, wherein the protective cover is made of plastic or rubber.
